(19) United States
(12) Patent Application Publication
(10) Pub. No.: US 2006/0294511 A1
(43) Pub. Date: Dec. 28, 2006

(54) Method, system, and computer program product for deploying different versions of software in a single package

(75) Inventors: Timothy Simon Bartley, Burleigh Heads (AU); Michael Wallace Gray, Runaway Bay (AU); Alexander John Hennekam, Broadbeach Waters (AU); Peter Thoedore Waltenberg, Queensland (AU)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/158,537

(22) Filed: Jun. 22, 2005

(51) Int. Cl. G06F 9/44

(52) U.S. Cl. 717/168

(57) ABSTRACT

The present invention provides a method, system, and computer program product for deploying different versions of a software product in a single package. A method in accordance with an embodiment of the present invention comprises: providing a first version of a software product (e.g., a certified version); providing a second version of the software product (e.g., a non-certified version); packaging the first and second versions of the software product in a single package; and deploying the package to a user, wherein the user chooses which of the first and second versions of the software product is to be used.

### BACKGROUND OF THE INVENTION

1. Field of the Invention

The present invention generally relates to software. More particularly, the present invention provides a method, system, and computer program product for deploying different versions of software (e.g., a certified version and the latest update) in a single package.

2. Related Art

Some software products require security certification, for example, FIPS140-2 certification (Federal Information Processing Standards Publication 140-2 “Security Requirements for Cryptographic Modules”) or EAL4 certification (Evaluation Assurance Level 4). Obtaining this certification is expensive and slow, and the need to maintain certification often conflicts with other imperatives, such as rapid deployment of bug fixes and/or security updates.

Known solutions tend to be procedural: “wait for the next certification round,” or “don't release software with bugs.” The result is that the software provider often ends up making decisions on deployment that cannot meet the requirements of all customers. For security software in particular, such compromises are risky for the software provider to make, and tend to result in an inconsistent security or certification profile.

Another option is to ship non-certified versions of a software product in response to bug fixes and/or security updates. For software products that aggregate function provided by multiple sources (e.g., an IBM Crypto for C (ICC) library), however, this option does not work well—differing release schedules and levels of security exposure for the subsystems of such software products make it very difficult to ensure a consistent security or certification profile.

### SUMMARY OF THE INVENTION

The present invention packages a plurality of versions of the same software (e.g., a certified version and the latest update) in a single package, and provides initialization code that gives a customer a runtime choice of using one of the versions of the software. To this extent, the software provider no longer has to make choices for their customers, updates (e.g., bug fixes and/or security updates) can still be deployed rapidly, and the customer can make the assessments of risk exposure and precisely craft their response to match their circumstances. Using the present invention, the customer can control without ambiguity whether their software is running in certified mode or with the latest bug fixes or security updates.

A first aspect of the present invention is directed to a method for deploying software, comprising: providing a first version of a software product; providing a second version of the software product; packaging the first and second versions of the software product in a single package; and deploying the package to a user, wherein the user chooses which of the first and second versions of the software product is to be used.

A second aspect of the present invention is directed to a method for deploying software, comprising: packaging a certified version and a non-certified version of a software product in a single package; and deploying the package to a user, wherein the user chooses which of the certified and non-certified versions of the software product is to be used.

A third aspect of the present invention provides a system for deploying software, comprising: a system for packaging a certified version and a non-certified version of a software product in a single package; and a system for deploying the package to a user, wherein the user chooses which of the certified and non-certified versions of the software product is to be used.

A fourth aspect of the present invention provides a program product stored on a computer readable medium for deploying software, the computer readable medium comprising program code for performing the following steps: packaging a certified version and a non-certified version of a software product in a single package; and deploying the package to a user, wherein the user chooses which of the certified and non-certified versions of the software product is to be used.

A fifth aspect of the present invention provides a method for deploying an application for deploying software, comprising: providing a computer infrastructure being operable to: package a certified version and a non-certified version of a software product in a single package; and deploy the package to a user, wherein the user chooses which of the certified and non-certified versions of the software product is to be used.

A sixth aspect of the present invention provides computer software embodied in a propagated signal for deploying software, the computer software comprising instructions to cause a computer system to perform the following functions: package a certified version and a non-certified version of a software product in a single package; and deploy the package to a user, wherein the user chooses which of the certified and non-certified versions of the software product is to be used.

A seventh aspect of the present invention provides a software package comprising: a security certified version a software product comprising a library of functions; and a non-security-certified version of the software product.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative system in accordance with an embodiment of the present invention.

FIG. 2 depicts an illustrative system in accordance with a more detailed embodiment of the present invention.

FIG. 3 depicts a flow diagram of a method in accordance with an embodiment of the present invention.

FIG. 4 depicts an illustrative computer system for implementing embodiments of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

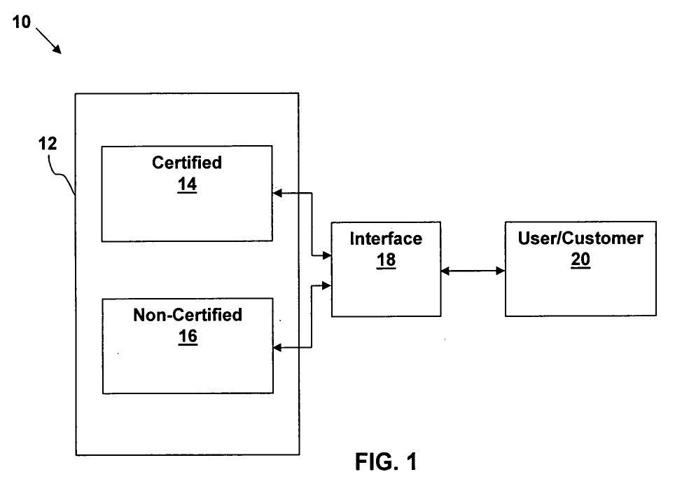

An illustrative system 10 in accordance with an embodiment of the present invention is depicted in FIG. 1. The system 10 comprises two different versions of the same software product (hereafter referred to as “software”) that are provided in a single package 12 in such a way that the two different versions can simultaneously co-exist within the same process space. For example, if the two different versions of the software are written in C/C++ code, the instances of the code can be namespaced (i.e., all public symbols have a unique prefix) so that there are no symbol conflicts. Advantageously, since the code is namespaced, it is possible to confirm, for example with a debugger, that the correct code paths are being used so the status of the software can be checked by an external auditor if necessary. It should be noted that namespacing is typically used to avoid conflicts between code that happens to have the same public symbols, but which implements quite different (incompatible) functions. In accordance with the present invention, however, namespacing is used to allow nearly identical implementations to co-exist within the same process space.

The system 10 comprises a certified version 14 of the software (e.g., FIPS140-2 or EAL4 certification) and a non-certified version 16 of the software. The non-certified version 16 of the software can comprise, for example, the latest updated version (e.g., bug fixes and/or security updates) of the software that has not yet qualified for certification. In general, the two versions 14, 16 of the software are nearly identical, with only minor changes to function. An interface 18 is provided for allowing a customer 20 to selectively access (e.g., install or use) either the certified version 14 of the software or the non-certified version 16 of the software based on their needs. For example, if the customer 20 determines that certification is more important than having the latest update, then they can select to access the certified version 14 of the software. Analogously, if the customer 20 determines that having the latest update takes precedence over certification, then they can choose to access the non-certified version 16 of the software. Although shown as including only two different versions 14, 16 of the same software, it will be apparent to one skilled in the art that the present invention can be extended for use with any number of different versions of the software, which may or may not include a certified version.

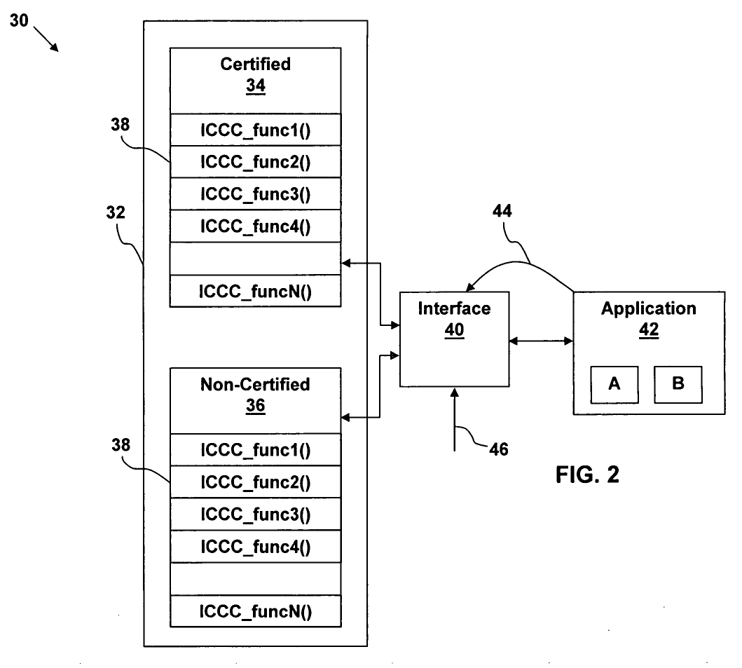

A more detailed system 30 in accordance with an embodiment of the present invention is depicted in FIG. 2. In this example, the software comprises two different versions of the same dynamic IBM Crypto for C (ICC) library, provided in a single package 32. The system 30 includes a certified version 34 of the dynamic ICC library that provides FIPS140-2 certified cryptography and a non-certified version 36 of the ICC library that includes the latest updates (e.g., bug fixes and/or security updates). Each version 34, 36 of the dynamic ICC library includes the same cryptographic functions 38 (e.g., ICCC_func1( ), ICCC_func2( ), . . . , ICCC_funcN( )).

An interface 40 is provided that allows application(s) 42 to specify via an initialization call 44 which functions 38 to use and whether to use functions 38 from the certified version 34 of the dynamic ICC library or from the non-certified version 36 of the dynamic ICC library. The initialization call 44 can comprise, for example, “function XYZ: certified” or “function ABC: updated.” The application can also specify that it “doesn't care” which version 34, 36 of the dynamic ICC library is used. In this case, the decision of whether to use functions 38 from the certified version 34 of the dynamic ICC library or from the non-certified version 36 of the dynamic ICC library can be set according to a default behavior (e.g., “if don't care use certified” or “if don't care use updated”), or can be dictated based on user-defined requirements as set forth in an environmental variable 46 (e.g., “must use certified” or “must use updated”). Other methodologies for specifying which functions 38 to use and whether to use functions 38 from the certified version 34 of the dynamic ICC library or from the non-certified version 36 of the dynamic ICC library are also possible. This process can be generalized for use with any type of library that contains/provides a plurality of different functional components.

Multiple applications often use the same library of functional components. These applications may themselves be aggregated into higher level products, and so on. Advantageously, in accordance with the present invention, the differing applications within such an aggregated product can actually be configured to use different variants (e.g., certified and non-certified) of the functional components within a library—and the aggregated product will still function properly. That is, the present invention provides runtime co-existence where both instances of the software can run with the same process at the same time. With reference to FIG. 2, for example, assume that two different applications A and B are combined to form the application 42 and, by default, both applications A and B are configured to use cryptographic functions 38 from the certified version 34 of the dynamic ICC library. Although application A operates securely using cryptographic functions 38 from the certified version 34 of the dynamic ICC library, application B requires a bug-fix provided by a function 38 in the non-certified version 36 of the dynamic ICC library to operate securely. Thus, application 42 uses functions 38 from both the certified and non-certified versions 34, 36 of the dynamic ICC library at the same time.

Updates to a package (e.g., packages 12, 32) can be made at any time without necessarily invalidating certification, provided an instance of the certified version of the software is always present. To cater to bug fixes and security updates, the package can be re-released, keeping the last certified version of the software and updating the non-certified version of the software. Other updating techniques can also be used. For example, updates can be provided in a known manner via an installer that updates the non-certified version of the software. The package can also be re-released when a newer certified version of the software becomes available.

The present invention makes it much easier for a software provider to meet the individual requirements of most (if not all) of their customers, because each customer is provided with both a certified version and the latest updated version of the software. Each customer can then evaluate the risks/tradeoffs involved with the different versions of the software and make an informed decision of which version to use based on their particular circumstances.

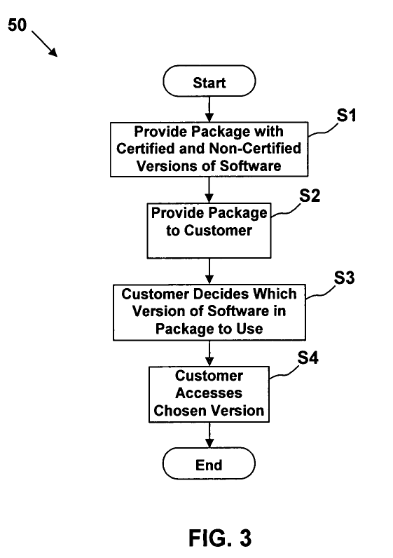

A general flow diagram 50 of a method in accordance with an embodiment of the present invention is depicted in FIG. 3. In step S1, a software provider provides a package containing both a certified version and a non-certified version of the same software. The non-certified version of the software can comprise, for example, the latest updated version (e.g., bug fixes and/or security updates) of the software that has not yet qualified for certification. In step S2, the package containing the certified and non-certified versions of the software is provided to a customer. In step S3, the customer decides whether to use the certified or the non-certified version of the software, based on their own unique requirements. In step S4, the customer accesses the chosen version of the software.

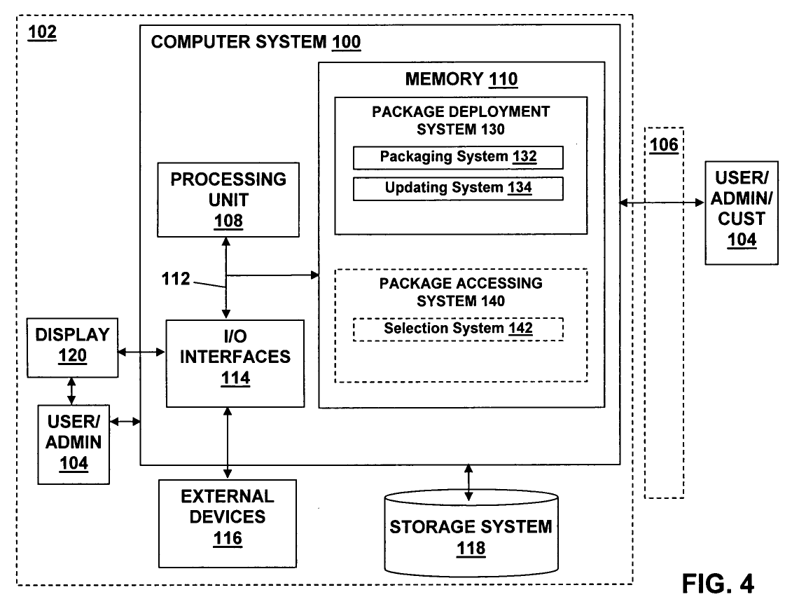

A computer system 100 for implementing embodiments of the present invention is depicted in FIG. 4. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. It should be appreciated that a user/administrator/customer 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user/administrator/customer-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as package deployment system 130 or package accessing system 140, stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 4 can be included in computer system 100. However, if computer system 100 comprises a handheld device or the like, it is understood that one or more external devices/resources 116 (e.g., a display) and/or one or more storage system(s) 118 can be contained within computer system 100, and not externally as shown.

Storage system(s) 118 can be any type of system (e.g., a database) capable of providing storage for information under the present invention. Such information can include, for example, a package containing both a certified version and a non-certified version of the same software, etc. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user/administrator/customer 104 can contain computerized components similar to those described above with regard to computer system 100.

Shown in memory 110 (e.g., as a computer program product) is a package deployment system 130 for deploying a package containing both a certified and a non-certified version of the same software, in accordance with an embodiment of the present invention (in this case it is assumed that computer system 100 is used by a provider of the software). Also shown (in phantom) in memory 110 (e.g., as a computer program product) is a package accessing system 140 for accessing software in a package containing both a certified and a non-certified version of the same software provided by a software provider for installation on the computer system 100, in accordance with an embodiment of the present invention (in this case it is assumed that computer system 100 is used by a customer of the software).

The package deployment system 130 includes a packaging system 132 for packaging a certified and a non-certified version of the same software together, such that the versions can simultaneously co-exist within the same process space. For example, if the two different versions of the software are written in C/C++ code, the instances of the code can be namespaced (i.e., all public symbols have a unique prefix) so that there are no symbol conflicts. The package deployment system 130 also includes an updating system 134 for updating the non-certified version of the software (e.g., in response to bug fixes and/or security updates) as described above.

The package accessing system 140 includes a selection system 142 for selecting which version (e.g., certified or non-certified) of the software in a package is to be used. The selected version of the software can then be deployed/installed/etc. as required.

The present invention can be offered as a business method on a subscription or fee basis. For example, one or more components of the present invention can be created, maintained, supported, and/or deployed by a service provider that offers the functions described herein for customers.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for deploying software, comprising:
providing a first version of a software product;
providing a second version of the software product;
packaging the first and second versions of the software product in a single package; and
deploying the package to a user, wherein the user chooses which of the first and second versions of the software product is to be used.

2. The method of claim 1, wherein the first version of the software product comprises a certified version of the software product, and wherein the second version of the software product comprises a non-certified version of the software product.

3. The method of claim 2, wherein the non-certified version of the software product comprises a latest updated version of the software product.

4. The method of claim 2, wherein the certified version of the software product is security certified.

5. The method of claim 2, wherein the software product comprises a library of functions.

6. The method of claim 5, wherein the functions comprise cryptographic functions.

7. The method of claim 5, wherein functions from both the certified and non-certified versions of the software product can be used at the same time.

8. Deploying an application for deploying software, comprising:
providing a computer infrastructure being operable to perform the method of claim 1.

9. Computer software embodied in a propagated signal for deploying software, the computer software comprising instructions to cause a computer system to perform the method of claim 1.

10. A program product stored on a computer readable medium for deploying software, the computer readable medium comprising program code for performing the method of claim 1.

11. A method for deploying software, comprising:
packaging a certified version and a non-certified version of a software product in a single package; and
deploying the package to a user, wherein the user chooses which of the certified and non-certified versions of the software product is to be used.

12. The method of claim 11, wherein the non-certified version of the software product comprises a latest updated version of the software product.

13. The method of claim 11, wherein the certified version of the software product is security certified.

14. The method of claim 11, wherein the software product comprises a library of functions.

15. The method of claim 14, wherein the functions comprise cryptographic functions.

16. The method of claim 14, wherein functions from both the certified and non-certified versions of the software product can be used at the same time.

17. Deploying an application for deploying software, comprising:
providing a computer infrastructure being operable to perform the method of claim 11.

18. Computer software embodied in a propagated signal for deploying software, the computer software comprising instructions to cause a computer system to perform the method of claim 11.

19. A program product stored on a computer readable medium for deploying software, the computer readable medium comprising program code for performing the method of claim 11.

20. A system for deploying software, comprising:
a system for packaging a certified version and a non-certified version of a software product in a single package; and
a system for deploying the package to a user, wherein the user chooses which of the certified and non-certified versions of the software product is to be used.

21. The system of claim 20, wherein the non-certified version of the software product comprises a latest updated version of the software product.

22. The system of claim 20, wherein the certified version of the software product is security certified.

23. The system of claim 20, wherein the software product comprises a library of functions.

24. The system of claim 23, wherein the functions comprise cryptographic functions.

25. The system of claim 23, wherein functions from both the certified and non-certified versions of the software product can be used at the same time.

26. A software package comprising:
a security certified version a software product comprising a library of functions; and
a non-security-certified version of the software product.
